(19) United States
(12) Patent Application Publication
(10) Pub. No.: US 2017/0235640 A1
(43) Pub. Date: Aug. 17, 2017

(54) NETWORK TRAFFIC RECORDING APPARATUS AND METHOD

(71) Applicant: ELECTRONICS AND TELECOMMUNICATIONS RESEARCH INSTITUTE, Daejeon (KR)

(72) Inventors: Joo-Young LEE, Daejeon (KR); Ik-Kyun KIM, Daejeon (KR); Jong-Hyun KIM, Daejeon (KR); Sun-Oh CHOI, Daejeon (KR); Yang-Seo CHOI, Daejeon (KR)

(21) Appl. No.: 15/360,957

(22) Filed: Nov. 23, 2016

(30) Foreign Application Priority Data
Feb. 15, 2016 (KR) 10-2016-0017135

(51) Int. Cl. G06F 11/14; G06F 17/30; H04L 29/08

(52) U.S. Cl. CPC G06F 11/1448; H04L 67/10; G06F 17/30094; G06F 2201/82

(57) ABSTRACT

Disclosed herein are a network traffic recording apparatus and method. The network traffic recording apparatus includes a data partitioning unit for generating a single data block from original data corresponding to a certain unit and partitioning the single data block into preset units, a data integrity verification information generation unit for generating data integrity verification information for each data block, and a data redundancy elimination encoding unit for performing redundancy elimination on data, which is a target of redundancy elimination, for each data block.

### CROSS REFERENCE TO RELATED APPLICATION

This application claims the benefit of Korean Patent Application No. 10-2016-0017135, filed Feb. 15, 2016, which is hereby incorporated by reference in its entirety into this application.

### BACKGROUND OF THE INVENTION

1. Technical Field

The present invention generally relates to a network traffic recording apparatus and method and, more particularly, to technology that stores required data while eliminating redundant data, and is then capable of guaranteeing the integrity of reconstructed data when the original data is reconstructed.

2. Description of the Related Art

With the development of devices such as smart phones and tablet PCs, the amount of mobile data traffic using those devices has also rapidly increased. The increase in the amount of mobile data traffic may cause a serious network load in a wireless network environment.

In particular, in a network structure in which a single base station (or a repeater) manages a plurality of terminals, the base station delivers data traffic to all terminals falling within its coverage area, and thus a serious bottleneck phenomenon occurs in the base station as the number of terminals and the amount of data provided by the terminals increase. As a result, the time at which the base station delivers data to each terminal is delayed, and the bandwidth available to deliver data to each terminal is also reduced, thus making it impossible for the terminals to be provided with high-quality services.

To solve this problem, a network-level redundancy elimination (RE) algorithm has been proposed. Such an RE algorithm may reduce traffic within a network by effectively eliminating redundant traffic from the standpoint of a network layer.

Further, as the amount of data to be stored has rapidly increased, such an RE algorithm enables original data to be reconstructed if necessary while storing required data after deleting redundant data, thus realizing various advantages, including not only reducing the storage space required to store data, but also shortening the relative transmission time compared to the transmission of the original data when the data is transmitted over a network.

However, after the redundancy-eliminated data has been reconstructed, verification of the integrity of the reconstructed data is required. Recently, as the number of cases where digital data is utilized as legal evidence data has increased, the need to verify the integrity of stored data has continually increased. Further, even if required data is stored after redundant data is eliminated when data is stored, as described above, it is known that hash functions, which are widely used to determine redundancy, have the possibility of collisions. Accordingly, there is a need to determine that the reconstructed data is identical to the original data, but conventional technology does not provide such an integrity verification method.

In connection with this, Korean Patent No. KR 10-1465891 discloses a technology related to “Traffic redundancy elimiation method and apparatus in wireless network.”

### SUMMARY OF THE INVENTION

Accordingly, embodiments of the present invention are intended to provide a network traffic recording apparatus and method, which generate integrity verification information required to verify integrity from original data and store the integrity verification information when redundant data is eliminated, and which verify the integrity of reconstructed data using the integrity verification information when data is reconstructed.

The objects of the present invention are not limited to the above-described object, and other objects that are not described here will be clearly understood by those skilled in the art from the following description.

In accordance with an aspect of the present invention, there is provided a network traffic recording apparatus, including a data partitioning unit for generating a single data block from original data corresponding to a certain unit and partitioning the single data block into preset units; a data integrity verification information generation unit for generating data integrity verification information for each data block; and a data redundancy elimination encoding unit for performing redundancy elimination on data, which is a target of redundancy elimination, for each data block.

The data partitioning unit may be configured to partition the single data block into units of first segment data, and partition the single data block so that the first segment data is separated into second segment data, which is not a target of redundancy elimination, and third segment data, which is a target of redundancy elimination.

The data integrity verification information generation unit may generate hash values by individually applying a cryptographic hash function to all of the second segment data and the third segment data for each data block.

The data integrity verification information generation unit may generate the data integrity verification information in parallel for each data block.

The data redundancy elimination encoding unit may perform redundancy elimination data encoding for each data block, and perform a hash table encoding procedure on a hash table obtained from results of performing the redundancy elimination data encoding.

The data redundancy elimination encoding unit may be configured, for performing redundancy elimination data encoding for each data block, to store values of the second segment data in an output buffer without change and to perform a redundancy elimination procedure on the third segment data.

The data redundancy elimination encoding unit may be configured, for performing the redundancy elimination procedure on the third segment data, to determine whether a hash value for the third segment data is present in the hash table, to obtain an index of the hash value from the hash table if it is determined that the hash value is present in the hash table, and to store the index in the output buffer.

The data redundancy elimination encoding unit may be configured to, if it is determined that the hash value is not present in the hash table, store a tuple composed of the hash value (Key), third segment data (Value), which is original data of the hash value, and a length of the third segment data (Length) in the hash table, and obtain a storage location of the tuple in the hash table as an index of the tuple.

The data redundancy elimination encoding unit may be configured, for performing the hash table encoding procedure, to store a number of tuples included in the hash table in the output buffer.

The data redundancy elimination encoding unit may be configured, for performing the hash table encoding procedure, to store each row corresponding to a tuple composed of only third segment data, which is original data of a hash value, and a length of the third segment data, which is the original data, among the tuples in the hash table, in the output buffer.

The network traffic recording apparatus may further include a redundancy elimination reconstruction decoding unit for reconstructing redundancy-eliminated data in accordance with the original data when a data reconstruction request is received.

The redundancy elimination reconstruction decoding unit may reconstruct the redundancy-eliminated data using results of performing the redundancy elimination data encoding and results of performing the hash table encoding procedure.

The redundancy elimination reconstruction decoding unit may be configured to read the second segment data and store the second segment data in a result buffer, and perform a redundancy elimination reconstruction procedure on the third segment data.

The redundancy elimination reconstruction decoding unit may be configured, for performing the redundancy elimination reconstruction procedure on the third segment data, to acquire original data of the third segment data using both a length of third segment data (Length), which is original data mapped to an index value, and the third segment data (Value), which is original data of a hash value, from the hash table.

The redundancy elimination reconstruction decoding unit may be configured to, when partial first segment data corresponding to a part of a redundancy-eliminated data block is reconstructed, determine a number indicating a sequential position of the partial first segment data, desired to be reconstructed, in the redundancy-eliminated data block, calculate a storage location of the partial first segment data, desired to be reconstructed, in the redundancy-eliminated data block, and perform redundancy elimination reconstruction on first segment data positioned at the calculated storage location.

The network traffic recording apparatus may further include a data integrity verification unit for verifying whether integrity of a reconstructed data block has been maintained using the data integrity verification information.

The data integrity verification unit may be configured, for verifying the integrity of the reconstructed data block, to determine whether a hash for second segment data and third segment data of the reconstructed data block is identical to data integrity verification information of the data block generated from the original data and to then verify whether the integrity of the reconstructed data block has been maintained.

The data integrity verification unit may be configured, for verifying integrity of the reconstructed partial first segment data, to compare a hash for second segment data and third segment data of the reconstructed partial first segment data with data integrity verification information of first segment data corresponding to the part of the data block generated from the original data and to then verify whether the integrity of the reconstructed partial first segment data has been maintained.

In accordance with another aspect of the present invention, there is provided a network traffic recording apparatus, including a data partitioning unit for generating a single data block from original data corresponding to a certain unit and partitioning the single data block into preset units; a data integrity verification information generation unit for generating data integrity verification information for each data block; a data redundancy elimination encoding unit for performing redundancy elimination on data, which is a target of redundancy elimination, for each data block; a redundancy elimination reconstruction decoding unit for reconstructing redundancy-eliminated data in accordance with the original data when a data reconstruction request is received; and a data integrity verification unit for verifying whether integrity of reconstructed data has been maintained using the data integrity verification information.

In accordance with a further aspect of the present invention, there is provided a network traffic recording method, including generating a single data block from original data corresponding to a certain unit and partitioning the single data block into preset units; generating data integrity verification information for each data block; performing redundancy elimination on data, which is a target of redundancy elimination, for each data block; reconstructing redundancy-eliminated data in accordance with the original data when a data reconstruction request is received; and verifying whether integrity of reconstructed data has been maintained using the data integrity verification information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of a network traffic recording apparatus according to an embodiment of the present invention;

FIG. 2 is a diagram showing the structure of segment data according to an embodiment of the present invention;

FIG. 3 is a diagram showing a hash tree for generating integrity verification information using a hash function according to an embodiment of the present invention;

FIG. 4 is a diagram illustrating a data block according to an embodiment of the present invention;

FIG. 5 is a diagram illustrating a hash table using third segment data according to an embodiment of the present invention;

FIG. 6 is a diagram illustrating redundancy elimination data encoding performed on a data block according to an embodiment of the present invention;

FIG. 7 is a diagram illustrating hash table encoding according to an embodiment of the present invention;

FIG. 8 is a flowchart showing a processing method performed by the network traffic recording apparatus according to an embodiment of the present invention; and

FIG. 9 is a configuration diagram of a computer system to which the network traffic recording apparatus is applied according to an embodiment of the present invention.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. It should be noted that the same reference numerals are used to designate the same or similar elements throughout the drawings. In the following description of the present invention, detailed descriptions of known functions and configurations which are deemed to make the gist of the present invention obscure will be omitted.

Further, terms such as “first”, “second”, “A”, “B”, “(a)”, and “(b)” may be used to describe the components of the present invention. These terms are merely used to distinguish relevant components from other components, and the substance, sequence or order of the relevant components is not limited by the terms. Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not to be interpreted as having ideal or excessively formal meanings unless they are definitely defined in the present specification.

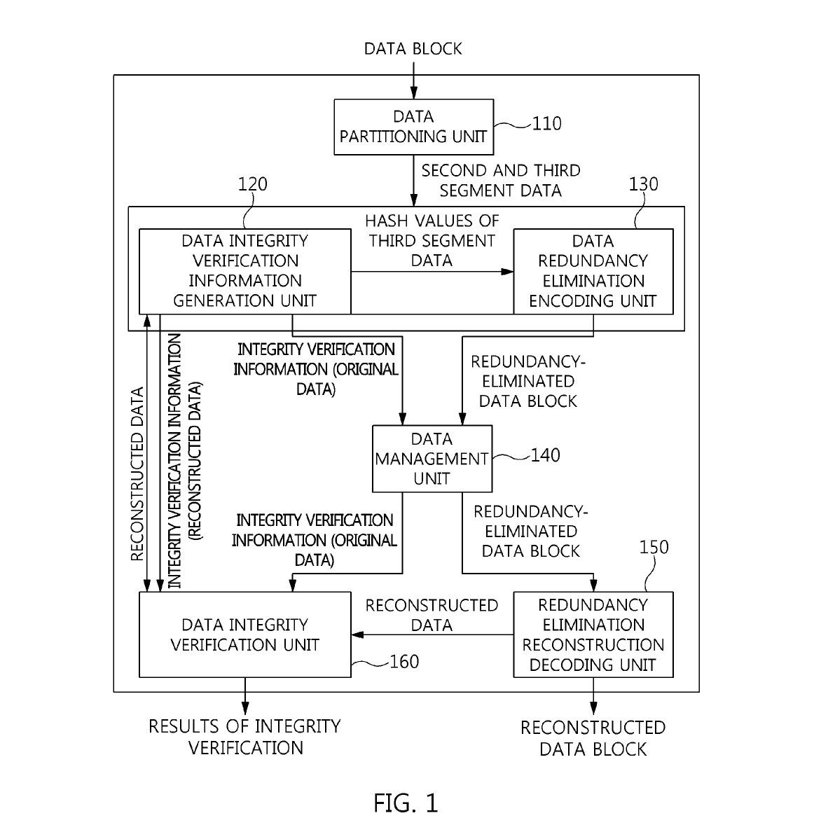

Hereinafter, embodiments of the present invention will be described in detail with reference to FIGS. 1 to 9.

FIG. 1 is a configuration diagram of a network traffic recording apparatus according to an embodiment of the present invention.

Referring to FIG. 1, the network traffic recording apparatus according to the embodiment of the present invention includes a data partitioning unit 110, a data integrity verification information generation unit 120, a data redundancy elimination encoding unit 130, a data management unit 140, a redundancy elimination reconstruction decoding unit 150, and a data integrity verification unit 160.

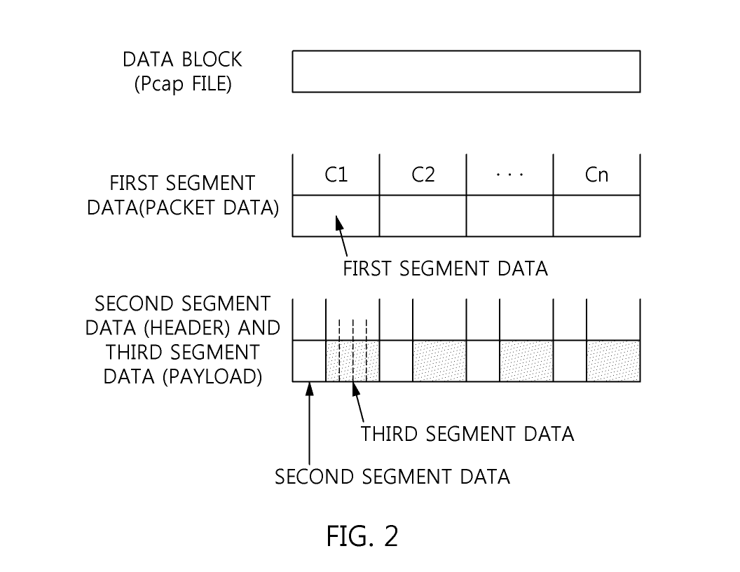

The data partitioning unit 110 generates a single data block when data corresponding to a data size of a certain unit is collected while input network traffic is buffered, and partitions the single data block into first segment data, second segment data, and third segment data, as shown in FIG. 2.

Referring to FIG. 2, the data partitioning unit 110 generates pieces of first segment data by partitioning the data block into preset units, and classifies pieces of data that are not the target of redundancy elimination, among the pieces of first segment data, as second segment data.

Thereafter, the data partitioning unit 110 classifies pieces of data that are the target of redundancy elimination, among the pieces of first segment data, as third segment data, and may additionally partition the third segment data into one or more pieces of data.

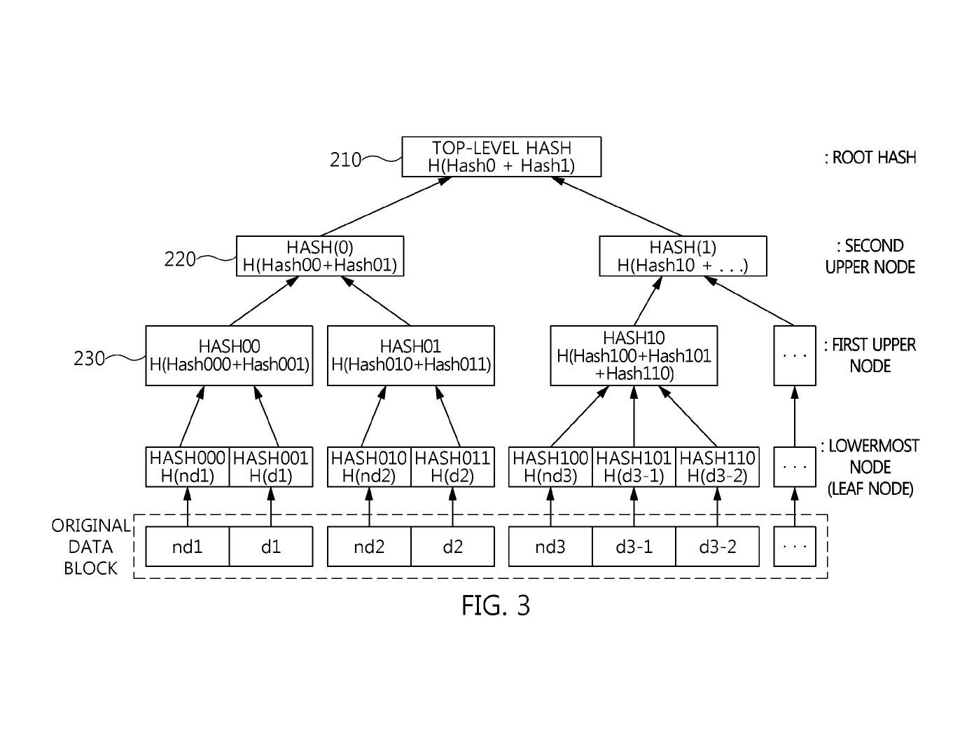

The data integrity verification information generation unit 120 generates data integrity verification information for each data block shown in FIG. 2. The data integrity verification information generation unit 120 generates hash values by applying a cryptographic hash function to all pieces of second segment data and to all pieces of third segment data of the data block. These hash values may be lowermost (bottom-level) nodes (i.e. leaves or leaf nodes) in the hash tree of FIG. 3.

The data integrity verification information generation unit 120 generates a hash chain using hash values of the second segment data and the third segment data while maintaining the data sequence of the data block. When generating the hash chain, the data integrity verification information generation unit 120 may generate first upper nodes above the lowermost nodes (leaves) such that a single first upper node is generated for each piece of first segment data. The data integrity verification information generation unit 120 may set the number of lower nodes to be included in the calculation of a single upper node when a subsequent upper node chain is generated.

The data integrity verification information generation unit 120 constructs a hash tree by processing such hash chains, and generates chains until the number of uppermost (top-level) nodes is 1. Here, an uppermost node is set to a root hash. As shown in FIG. 3, as the data integrity verification information required to verify the integrity of the entire data block, a root hash 210 may be used. Further, as the data integrity verification information required to verify a part of the data block, top-level hashes of sub-hash trees 220 and 230, each composed of hash values for a part of the data block in the overall hash tree, may be used. Furthermore, the data integrity verification information generation unit 120 may perform procedures for generating data integrity verification information in a parallel-processing manner.

The data redundancy elimination encoding unit 130 performs redundancy elimination data encoding and hash table encoding for each data block, and then generates a redundancy-eliminated data block including the results of redundancy elimination data encoding and results of hash table encoding for each data block.

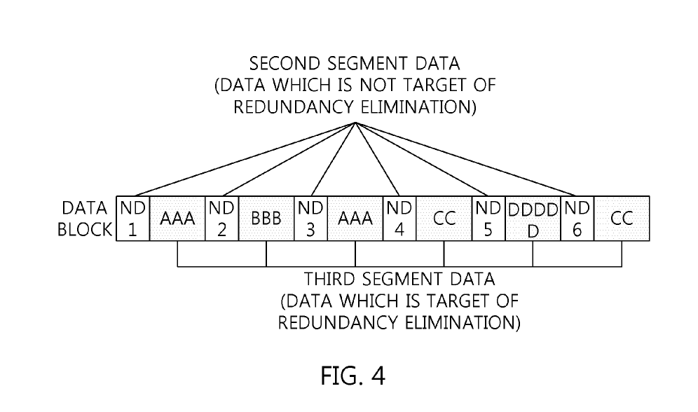

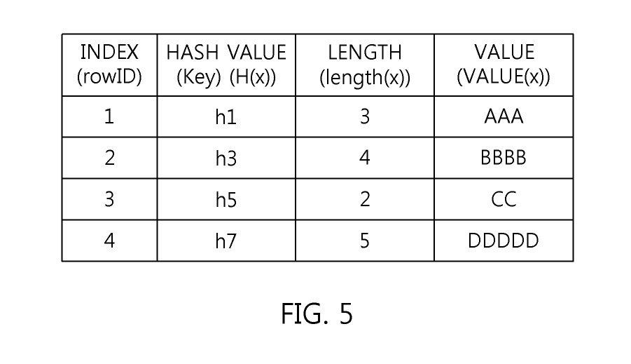

FIG. 4 is a diagram illustrating a data block including second segment data and third segment data, and FIG. 5 is a diagram illustrating a hash table using third segment data according to an embodiment of the present invention. Referring to FIG. 5, each row of the hash table is represented by a tuple composed of a hash value (Key), original data (Value) for the hash value, and the length of the third segment data (Length), which is the original data. The hash value is a unique value in the hash table.

The data redundancy elimination encoding unit 130 performs a redundancy elimination procedure only on the third segment data, which is the target of redundancy elimination in the data block, and thereafter repeatedly performs a redundancy elimination data encoding procedure on all pieces of first segment data in the data block.

In this case, the redundancy elimination data encoding procedure performed by the data redundancy elimination encoding unit 130 will be described in detail below.

First, the data redundancy elimination encoding unit 130 records the values of the second segment data in an output buffer (not shown) without change. Although the output buffer is not shown in the drawing, it is a typical buffer, and thus a detailed description thereof is omitted here. Meanwhile, the data redundancy elimination encoding unit 130 performs a subsequent redundancy elimination procedure on the third segment data.

The redundancy elimination procedure performed by the data redundancy elimination encoding unit 130 will be described in detail below.

First, the data redundancy elimination encoding unit 130 determines whether a hash value for the third segment data is present in a hash table. If no hash value is present in the hash table, the data redundancy elimination encoding unit 130 stores a tuple, composed of a hash value (Key), the third segment data (Value), which is the original data of the hash value, and the length of the third segment data (Length), which is the original data, in the hash table of FIG. 5, and the storage location of the tuple in the hash table is stored as an index of the tuple in the output buffer.

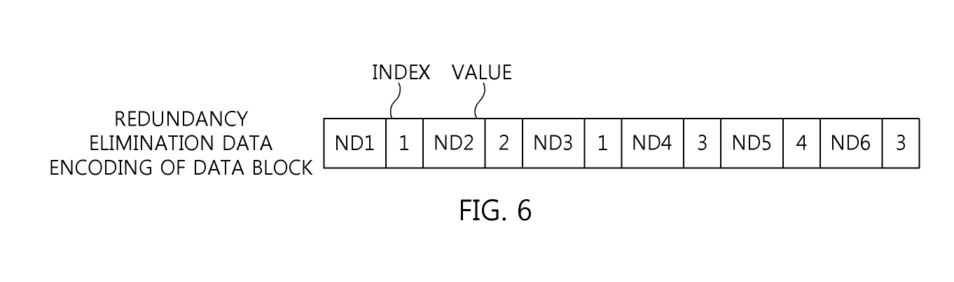

On the other hand, if the hash value is present in the hash table, the data redundancy elimination encoding unit 130 obtains the index of the hash value (Key) from the hash table and stores the index in the output buffer. In this regard, when the third segment data is additionally partitioned into at least two pieces of data, a procedure for obtaining an index is repeatedly performed. The results of performing the redundancy elimination encoding procedure on the data block may be illustrated, as shown in FIG. 6.

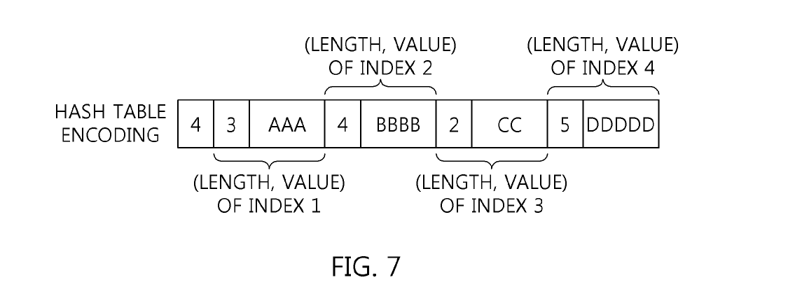

Thereafter, the data redundancy elimination encoding unit 130 performs a hash table encoding procedure on the hash table, which has been finally obtained via the redundancy elimination encoding procedure. In order to perform the hash table encoding procedure, the data redundancy elimination encoding unit 130 stores the number of tuples included in the hash table in the output buffer. Each row corresponding to a tuple composed of only third segment data (Value), which is the original data of the hash value, and the length of the third segment data (Length), which is the original data, among the tuples in the hash table, is stored in the output buffer. In this case, the data in the output buffer is a redundancy-eliminated data block for the data block. FIG. 7 illustrates the results of performing hash table encoding based on the hash table encoding procedure.

The data management unit 140 provides a function of preventing the data from changing after the corresponding data has been recorded, and enables network traffic to be continuously stored (recorded) by automatically deleting data when the size of the empty space in the storage becomes less than or equal to a preset size.

In this regard, in order to prevent the data from changing after the data has been stored, the data management unit 140 allocates a specific area in the storage as a virtual volume (i.e. creates the virtual volume), writes data to the virtual volume, and prevents data in the virtual volume from being further modified once the virtual volume is closed.

Meanwhile, in order to automatically delete data when the size of the empty space in the storage is less than or equal to the preset size, data is deleted in units of a virtual volume, and, in particular, data in the oldest virtual volume is deleted first.

The data management unit 140 stores both the data integrity verification information generated by the data integrity verification information generation unit 120 and the redundancy-eliminated data block generated by the data redundancy elimination encoding unit 130 in its internal storage (not shown).

The redundancy elimination reconstruction decoding unit 150 reconstructs the original of the redundancy-eliminated data using the results of redundancy elimination data encoding performed on the data block and the results of hash table encoding. In order to perform a reconstruction decoding procedure on the redundancy-eliminated data, the redundancy elimination reconstruction decoding unit 150 reads second segment data for each piece of first segment data in the data block, records the second segment data in a result buffer, and performs a redundancy elimination reconstruction procedure on the third segment data.

In order to perform the redundancy elimination reconstruction procedure on the third segment data, the redundancy elimination reconstruction decoding unit 150 first reads an index value and acquires the original data of each piece of third segment data using both the length of the third segment data (Length), which is the original data mapped to the index value, and the third segment data (Value), which is the original data of the hash value, from the hash table. Thereafter, the redundancy elimination reconstruction decoding unit 150 records the acquired original data in the result buffer. Here, the data recorded in the result buffer is the reconstructed data of the redundancy-eliminated data block.

Here, when the third segment data is partitioned into two or more pieces of data, the redundancy elimination reconstruction decoding unit 150 repeatedly performs the above-described redundancy elimination reconstruction procedure on the third segment data. Further, when there are two or more pieces of first segment data, the redundancy elimination reconstruction decoding unit 150 repeatedly performs a procedure for reading and recording second segment data and a redundancy elimination reconstruction procedure on third segment data.

Meanwhile, to reconstruct partial first segment data corresponding to a part of the redundancy-eliminated data block, the redundancy elimination reconstruction decoding unit 150 checks a number indicating the sequential position of the partial first segment data, desired to be reconstructed, in the redundancy-eliminated data block. Thereafter, the redundancy elimination reconstruction decoding unit 150 calculates the storage location of the partial first segment data, which is desired to be reconstructed, in the redundancy-eliminated data block. Here, the method for calculating the storage location of the partial first segment data desired to be reconstructed is given by the following Equation (1):

$$location ( {C}_{n} ) = {\sum }_{i = 1}^{n - 1} len ( {nd}_{i} ) + ( {sizeof ( idx )}^{*} count ( {d}_{i} ) ) \qquad ( 1 )$$

First segment data to be reconstructed (n-th): cₙ

Location of the first segment data to be reconstructed: location(cₙ)

Length of second segment data for i-th first segment data: len(ndᵢ)

The number of pieces of third segment data for i-th first segment data: count (dᵢ)

Size of data structure for storing an index: sizeof(idx)

The redundancy elimination reconstruction decoding unit 150 acquires the first segment data that is desired to be reconstructed from the redundancy-eliminated data block and performs the above-described redundancy elimination reconstruction decoding procedure.

The data integrity verification unit 160 verifies whether the integrity of the data block reconstructed by the redundancy elimination reconstruction decoding unit 150 has been maintained, and also verifies whether the integrity of the reconstructed partial first segment data has been maintained.

First, to perform a procedure for verifying whether the integrity of the reconstructed data block has been maintained, the data integrity verification unit 160 delivers the data to the data integrity verification information generation unit 120 in order to generate hashes of each piece of second segment data and each piece of third segment data reconstructed by the redundancy elimination reconstruction decoding unit 150. As a result of this operation, the root hash of the reconstructed data block is obtained from the data integrity verification information generation unit 120.

Then, the data integrity verification unit 160 acquires data integrity verification information for the original data block from the data management unit. Thereafter, the data integrity verification unit 160 checks whether the root hash of the reconstructed data block is identical to the data integrity verification information of the original data block. Thereafter, if it is checked that the root hash is identical to the data integrity verification information, the data integrity verification unit 160 determines that the integrity of the reconstructed data has been maintained, whereas if it is checked that the root hash is not identical to the data integrity verification information, the data integrity verification unit 160 determines that redundancy elimination reconstruction has failed.

Meanwhile, to perform the procedure for verifying whether the integrity of the reconstructed partial first segment data has been maintained, the data integrity verification unit 160 delivers the data to the data integrity verification information generation unit in order to generate hashes and hash chains for second segment data and the third segment data for the reconstructed partial first segment data. As a result of this operation, the root hash of the hash chains is obtained.

Thereafter, the data integrity verification unit 160 obtains a partial hash tree mapped to the original of the reconstructed partial first segment data from the data management unit, and uses the top-level hash value of the hash tree as data integrity verification information.

Then, the data integrity verification unit 160 checks whether the root hash of the reconstructed partial first segment data is identical to the data integrity verification information of the first segment data corresponding to a part of the original. If the root hash of the reconstructed partial first segment data is identical to the data integrity verification information, the data integrity verification unit 160 determines that the integrity of the reconstructed partial first segment data has been maintained, whereas if the root hash of the reconstructed partial first segment data is not identical to the data integrity verification information, the data integrity verification unit 160 determines that redundancy elimination reconstruction has failed.

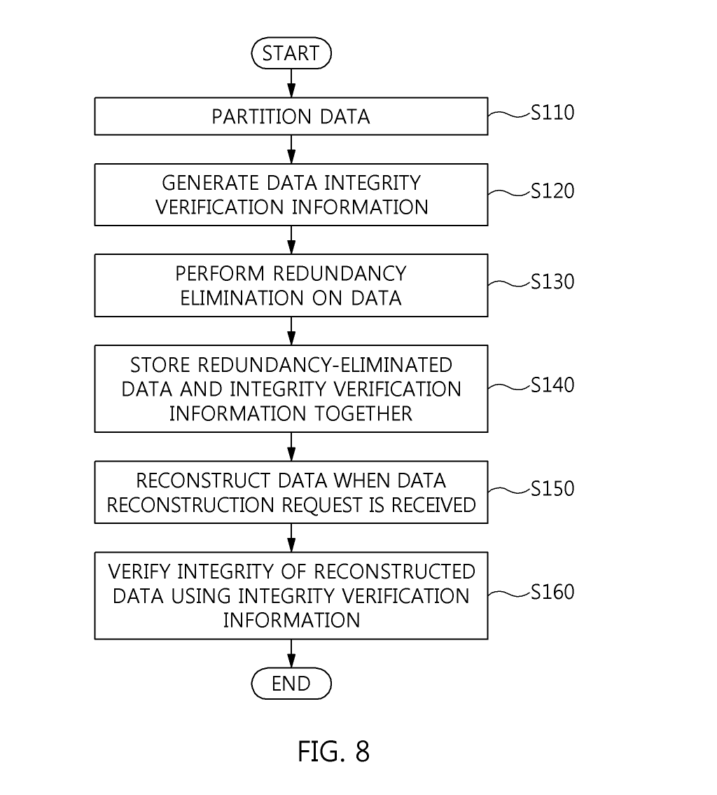

Hereinafter, referring FIG. 8, a processing method performed by the network traffic recording apparatus according to an embodiment of the present invention will be described in detail.

First, the data partitioning unit 110 generates a single data block from original data corresponding to a certain unit, which is input data, and partitions the single data block into preset units at step S110.

Thereafter, the data integrity verification information generation unit 120 generates data integrity verification information for each data block at step S120.

Then, the data redundancy elimination encoding unit 130 performs redundancy elimination on the data, which is the target of redundancy elimination, for each data block at step S130, and the data management unit 140 stores the data integrity verification information at step S140.

Next, the redundancy elimination reconstruction decoding unit 150 reconstructs the redundancy-eliminated data in accordance with the original data when a data reconstruction request is received at step S150.

Thereafter, the data integrity verification unit 160 verifies whether the integrity of the reconstructed data has been maintained using the data integrity verification information at step S160.

These procedures may be performed in parallel in a parallel-processing environment.

As described above, the present invention may save storage space required for data storage by storing required data after eliminating redundant data when recording network traffic, and may use data integrity verification information when the integrity of reconstructed data is verified by also storing the data integrity verification information of the original data, which was recorded during redundancy elimination, thus improving the reliability and usability of the data.

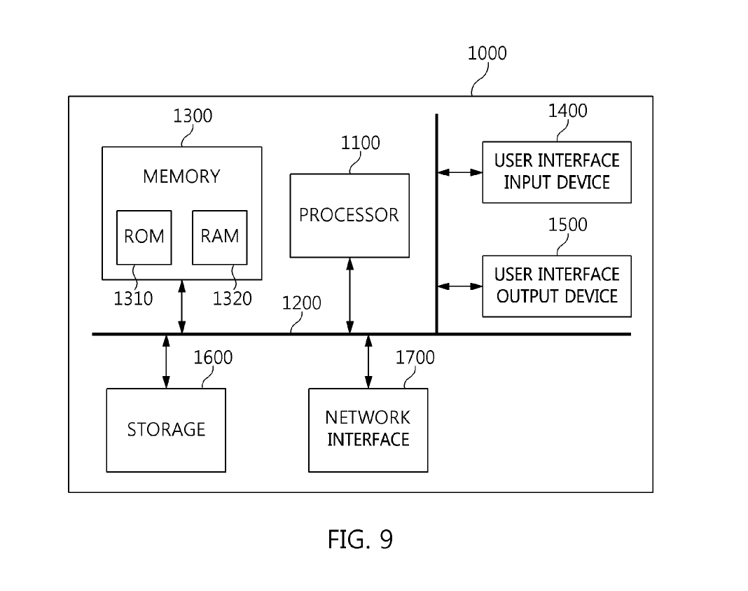

FIG. 9 is a configuration diagram of a computing system to which the network traffic recording apparatus according to the embodiment of the present invention is applied.

Referring to FIG. 9, the computing system 100 may include at least one processor 1100, memory 1300, a user interface input device 1400, a user interface output device 1500, storage 1600, and a network interface 1700, which are connected to each other through a bus 1200. The processor 1100 may be either a CPU or a semiconductor device for executing the processing of instructions stored in the memory 1300 and/or the storage 1600. Each of the memory 1300 and the storage 1600 may include any of various types of volatile or nonvolatile storage media. For example, the memory 1300 may include Read Only Memory (ROM) 1310 and Random Access Memory (RAM) 1320.

Therefore, steps of the method or the algorithm described in relation with the embodiments disclosed in the present specification may be directly implemented by a hardware module or a software module that is executed by the processor 1100 or by a combination of the two modules. The software module may reside in a storage medium (i.e. the memory 1300 and/or the storage 1600), such as RAM, flash memory, ROM, Erasable Programmable ROM (EPROM), Electrically Erasable Programmable ROM (EEPROM), a register, a hard disk, a removable disk, or a Compact Disk (CD)-ROM.

An exemplary storage medium may be coupled to the processor 1100, and the processor 1100 may read information from the storage medium and write information to the storage medium. Alternatively, the storage medium may be integrated with the processor 1100. The processor and the storage medium may also reside in an Application-Specific Integrated Circuit (ASIC). The ASIC may reside in a user terminal. Alternatively, the processor and the storage medium may reside as individual components in the user terminal.

The present technology may minimize the storage space required for data storage by eliminating redundant data when recording network traffic.

Further, the present technology may generate the data integrity verification information of stored original data while storing required data after eliminating redundant data of network traffic, and may verify the integrity of original data using the previously stored data integrity verification information of the original data when the original data is subsequently reconstructed, thus improving the reliability of the stored data and consequently enhancing the usability of the data.

Furthermore, the present technology may verify the integrity of the data when stored network traffic is subsequently the target of a network forensic investigation or is admitted as legal evidence.

Although the preferred embodiments of the present invention have been disclosed for illustrative purposes, those skilled in the art will appreciate that various modifications and changes are possible, without departing from the essential features of the invention as disclosed in the accompanying claims.

Therefore, the embodiments disclosed in the present invention are not intended to limit the technical spirit of the present invention and are merely intended to describe the invention, and the scope of the technical spirit of the present invention is not limited by those embodiments. The protection scope of the present invention should be defined by the accompanying claims, and all technical spirit of the accompanying claims and equivalents thereof should be construed as being included in the scope of the present invention.

What is claimed is:

1. A network traffic recording apparatus, comprising:
a data partitioning unit for generating a single data block from original data corresponding to a certain unit and partitioning the single data block into preset units;
a data integrity verification information generation unit for generating data integrity verification information for each data block; and
a data redundancy elimination encoding unit for performing redundancy elimination on data, which is a target of redundancy elimination, for each data block.

2. The network traffic recording apparatus of claim 1, wherein the data partitioning unit is configured to:
partition the single data block into units of first segment data, and
partition the single data block so that the first segment data is separated into second segment data, which is not a target of redundancy elimination, and third segment data, which is a target of redundancy elimination.

3. The network traffic recording apparatus of claim 2, wherein the data integrity verification information generation unit generates hash values by individually applying a cryptographic hash function to all of the second segment data and the third segment data for each data block.

4. The network traffic recording apparatus of claim 3, wherein the data integrity verification information generation unit generates the data integrity verification information in parallel for each data block.

5. The network traffic recording apparatus of claim 2, wherein the data redundancy elimination encoding unit performs redundancy elimination data encoding for each data block, and performs a hash table encoding procedure on a hash table obtained from results of performing the redundancy elimination data encoding.

6. The network traffic recording apparatus of claim 5, wherein the data redundancy elimination encoding unit is configured, for performing redundancy elimination data encoding for each data block, to store values of the second segment data in an output buffer without change and to perform a redundancy elimination procedure on the third segment data.

7. The network traffic recording apparatus of claim 6, wherein the data redundancy elimination encoding unit is configured, for performing the redundancy elimination procedure on the third segment data, to determine whether a hash value for the third segment data is present in the hash table, to obtain an index of the hash value from the hash table if it is determined that the hash value is present in the hash table, and to store the index in the output buffer.

8. The network traffic recording apparatus of claim 7, wherein the data redundancy elimination encoding unit is configured to, if it is determined that the hash value is not present in the hash table, store a tuple composed of the hash value (Key), third segment data (Value), which is original data of the hash value, and a length of the third segment data (Length) in the hash table, and obtain a storage location of the tuple in the hash table as an index of the tuple.

9. The network traffic recording apparatus of claim 5, wherein the data redundancy elimination encoding unit is configured, for performing the hash table encoding procedure, to store a number of tuples included in the hash table in the output buffer.

10. The network traffic recording apparatus of claim 9, wherein the data redundancy elimination encoding unit is configured, for performing the hash table encoding procedure, to store each row corresponding to a tuple composed of only third segment data, which is original data of a hash value, and a length of the third segment data, which is the original data, among the tuples in the hash table, in the output buffer.

11. The network traffic recording apparatus of claim 5, further comprising a redundancy elimination reconstruction decoding unit for reconstructing redundancy-eliminated data in accordance with the original data when a data reconstruction request is received.

12. The network traffic recording apparatus of claim 11, wherein the redundancy elimination reconstruction decoding unit reconstructs the redundancy-eliminated data using results of performing the redundancy elimination data encoding and results of performing the hash table encoding procedure.

13. The network traffic recording apparatus of claim 11, wherein the redundancy elimination reconstruction decoding unit is configured to:
read the second segment data and store the second segment data in a result buffer, and
perform a redundancy elimination reconstruction procedure on the third segment data.

14. The network traffic recording apparatus of claim 13, wherein the redundancy elimination reconstruction decoding unit is configured, for performing the redundancy elimination reconstruction procedure on the third segment data, to acquire original data of the third segment data using both a length of third segment data (Length), which is original data mapped to an index value, and the third segment data (Value), which is original data of a hash value, from the hash table.

15. The network traffic recording apparatus of claim 14, wherein the redundancy elimination reconstruction decoding unit is configured to, when partial first segment data corresponding to a part of a redundancy-eliminated data block is reconstructed,
determine a number indicating a sequential position of the partial first segment data, desired to be reconstructed, in the redundancy-eliminated data block,
calculate a storage location of the partial first segment data, desired to be reconstructed, in the redundancy-eliminated data block, and
perform redundancy elimination reconstruction on first segment data positioned at the calculated storage location.

16. The network traffic recording apparatus of claim 11, further comprising a data integrity verification unit for verifying whether integrity of a reconstructed data block has been maintained using the data integrity verification information.

17. The network traffic recording apparatus of claim 16, wherein the data integrity verification unit is configured, for verifying the integrity of the reconstructed data block, to determine whether a hash for second segment data and third segment data of the reconstructed data block is identical to data integrity verification information of the data block generated from the original data and to then verify whether the integrity of the reconstructed data block has been maintained.

18. The network traffic recording apparatus of claim 17, wherein the data integrity verification unit is configured, for verifying integrity of the reconstructed partial first segment data, to compare a hash for second segment data and third segment data of the reconstructed partial first segment data with data integrity verification information of first segment data corresponding to the part of the data block generated from the original data and to then verify whether the integrity of the reconstructed partial first segment data has been maintained.

19. A network traffic recording apparatus, comprising:
a data partitioning unit for generating a single data block from original data corresponding to a certain unit and partitioning the single data block into preset units;
a data integrity verification information generation unit for generating data integrity verification information for each data block;
a data redundancy elimination encoding unit for performing redundancy elimination on data, which is a target of redundancy elimination, for each data block;
a redundancy elimination reconstruction decoding unit for reconstructing redundancy-eliminated data in accordance with the original data when a data reconstruction request is received; and
a data integrity verification unit for verifying whether integrity of reconstructed data has been maintained using the data integrity verification information.

20. A network traffic recording method, comprising:
generating a single data block from original data corresponding to a certain unit and partitioning the single data block into preset units;
generating data integrity verification information for each data block;
performing redundancy elimination on data, which is a target of redundancy elimination, for each data block;
reconstructing redundancy-eliminated data in accordance with the original data when a data reconstruction request is received; and
verifying whether integrity of reconstructed data has been maintained using the data integrity verification information.
